(19) United States
(12) Patent Application Publication
(10) Pub. No.: US 2012/0176505 A1
(43) Pub. Date: Jul. 12, 2012

(54) METHOD AND APPARATUS FOR CAPTURING MOVING PICTURE

(75) Inventors: Eun-young KIM, Suwon-si (KR); Jang-won LEE, Seoul (KR)

(73) Assignee: Samsung Electronics Co., Ltd., Suwon-si (KR)

(21) Appl. No.: 13/282,761

(22) Filed: Oct. 27, 2011

(30) Foreign Application Priority Data
Jan. 11, 2011 (KR) 10-2011-0002881

(51) Int. Cl. H04N 5/228; G06K 9/00

(52) U.S. Cl. 348/222.1; 382/103; 348/E05.031

(57) ABSTRACT

A method and apparatus for photographing a moving picture divides an image into a focus area and a background area, photographs the focus area and the background area at different frame rates, stores images thereof, and combines the stored images, whereby a resolution restriction due to high speed moving picture photographing can be reduced.

### CROSS-REFERENCE TO RELATED PATENT APPLICATION

This application claims the priority benefit of Korean Patent Application No. 10-2011-0002881, filed on Jan. 11, 2011, in the Korean Intellectual Property Office, the disclosure of which is incorporated herein in its entirety by reference.

### BACKGROUND

1. Field of the Invention

Embodiments relate to a method and apparatus for capturing a moving picture.

2. Description of the Related Art

High speed moving picture photographing is performed by capturing and recording at a frame rate greater than a reproduction frame rate. For example, in a case where a moving picture is captured at a high speed of 1000 frames per second (fps), it is typically necessary that at least one frame is encoded every 1 millisecond (ms). Meanwhile, a recording resolution of high speed moving picture photographing is determined according to specifications of a sensor and thus a user typically cannot freely select a resolution for high speed moving picture photographing.

### SUMMARY

Embodiments include a method and apparatus for capturing a moving picture. The method and apparatus may capture a high resolution moving picture by reducing a resolution restriction due to high speed moving picture photographing, whereby a user may conveniently perform high speed photographing while automatically focusing on a moving target object.

According to an embodiment, a method of capturing a moving picture includes the operations of capturing an input image at a first frame rate; detecting a target object that moves in the input image; photographing a focus area including the target object at a second frame rate; and combining a first image captured at the first frame rate with a second image captured at the second frame rate.

A frame rate for capturing the input image may vary according to a speed of the target object.

The method may further include the operations of storing the first image in a first buffer; and storing the second image in a second buffer.

The method may further include the operation of recording the combined image on a recording medium.

The method may further include the operations of determining a speed of the target object; and when the speed of the target object is more than a first threshold value, setting the focus area including the target object.

The operation of capturing the input image may include the operation of capturing the input image at the first frame rate for a predetermined number of frames.

The first image may include a background area excluding the focus area.

The method may further include the operation of updating the focus area when a moving target object is detected in the first image.

According to another embodiment, a method of capturing a moving picture includes the operations of detecting a target object that moves in an input image; setting a frame rate for capturing the input image according to a speed of the target object; and capturing the input image according to the frame rate.

The method may further include the operation of setting a focus area including the target object, wherein the operation of setting the frame rate may include the operation of setting the frame rate as a faster frame rate with respect to the focus area, compared to a previously set frame rate.

The method may further include the operations of setting a focus area comprising the target object in the input image, and a background area excluding the focus area; storing a first image captured at a first frame rate with respect to the background area; storing a second image captured at a second frame rate faster than the first frame rate with respect to the focus area; and combining the first image with the second image.

According to another embodiment, a moving picture photographing apparatus includes an image sensor including at least two sensor modes that capture an input image at different frame rates; and a digital signal processing (DSP) unit that detects a target object that moves in the input image, and controls a focus area including the target object to be photographed at a frame rate faster than a previously set frame rate.

The image sensor may include a first sensor mode that captures the input image at a first frame rate; and a second sensor mode that photographs the focus area at a second frame rate.

The moving picture photographing apparatus may further include a first buffer that stores a first image obtained by capturing the input image at the first frame rate; and a second buffer that stores a second image obtained by photographing the focus area at the second frame rate. The DSP unit may combine the first image stored in the first buffer with the second image stored in the second buffer.

The DSP unit may include a motion detecting unit that detects a target object that moves in the input image; a focus area control unit that sets a focus area comprising the target object when a speed of the target object is equal to or greater than a first threshold value; a frame rate setting unit that sets a frame rate for photographing the focus area according to the speed of the target object; and a sensor control unit that determines a sensor mode of the image sensor according to the set frame rate.

The image sensor may include a first sensor mode that captures the input image at a first frame rate; and a second sensor mode that photographs the focus area at a second frame rate. The DSP unit may further include a memory control unit that controls a first image captured at the first frame rate to be stored in a first buffer and controls a second image captured at the second frame rate to be stored in a second buffer.

The DSP unit may further include an image composing unit that combines the first image stored in the first buffer with the second image stored in the second buffer.

The DSP unit may variably set a frame rate for capturing the input image, according to a speed of the target object.

### BRIEF DESCRIPTION OF THE DRAWINGS

The above and other features and advantages will become more apparent by describing in detail exemplary embodiments with reference to the attached drawings in which:

FIG. 1 illustrates a structure of a digital camera as an example of a moving picture photographing apparatus, according to an embodiment;

FIG. 2 is a block diagram of a digital signal processing (DSP) unit of FIG. 1 and its peripheral devices, according to an embodiment;

FIG. 3 illustrates graphs describing moving picture frames stored in a first buffer and a second buffer, according to an embodiment;

FIG. 4 is a flowchart describing a method of capturing a moving picture, according to an embodiment;

FIG. 5 illustrates an exemplary screen displaying a result image according to the method of capturing a moving picture; and

FIG. 6 is a flowchart describing a method of capturing a moving picture, according to another embodiment.

### DETAILED DESCRIPTION

Particular embodiments will be illustrated in the drawings and described in detail in the written description, although various changes and numerous other embodiments are permitted. The illustrated and described embodiments are not intended to be limiting to particular modes of practice, and it is to be appreciated that all changes, equivalents, and substitutes that do not depart from the spirit and technical scope are encompassed in the invention as defined by the following claims. In the description, certain detailed explanations of related art are omitted when it is deemed that they may unnecessarily obscure the essence of the embodiments.

While terms “first” and “second” are used to describe various components, it is to be understood that the components are not limited to the terms “first” and “second”. The terms “first” and “second” are used only to distinguish between each component.

The terms used in the present specification are merely used to describe particular embodiments, and are not intended to be limiting. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Embodiments will be described below in more detail with reference to the accompanying drawings. Those components that are the same or are in correspondence are rendered the same reference numeral regardless of the figure number, and redundant explanations are omitted.

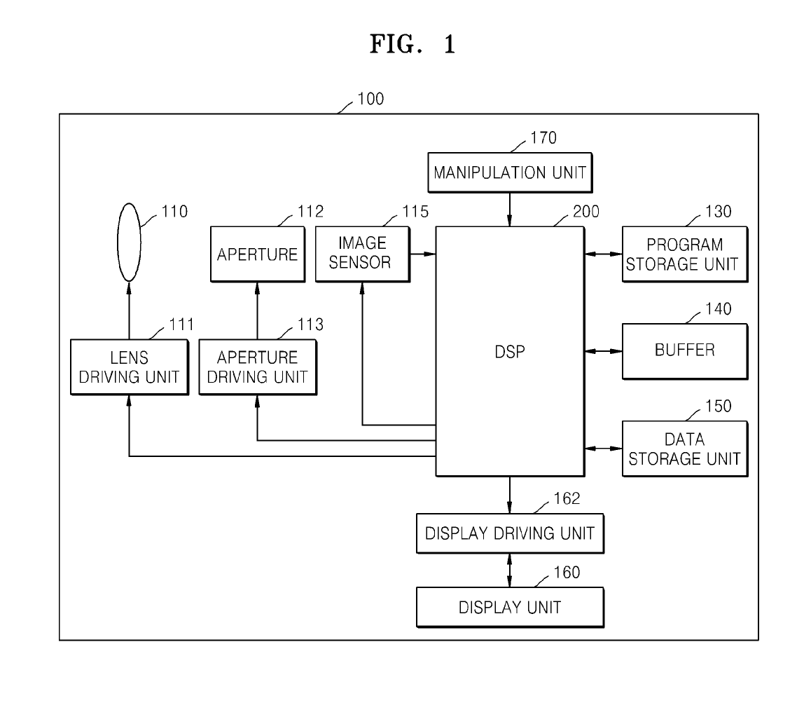

FIG. 1 illustrates a structure of a digital camera 100 as an example of a moving picture photographing apparatus, according to an embodiment.

The digital camera 100 will be described as an example of the moving picture photographing apparatus according to the present embodiment. However, the moving picture photographing apparatus is not limited to the digital camera 100 of FIG. 1 and thus may be applied to digital devices such as a camera phone, a personal digital assistant (PDA), a portable multimedia player (PDA), a camcorder, or the like.

The digital camera 100 may include a lens unit 110, a lens driving unit 111, an aperture 112, an aperture driving unit 113, an image sensor 115, a program storage unit 130, a buffer 140, a data storage unit 150, a display driving unit 162, a display unit 160, a digital signal processing (DSP) unit 200, and a manipulation unit 170. Here, the lens unit 110, the lens driving unit 111, the aperture 112, the aperture driving unit 113, and the image sensor 115 may be grouped and called a photographing unit.

The lens unit 110 collects an optical signal. The lens unit 110 may include a zoom lens for controlling an angle of view to be small or large according to a focal length, and a focus lens for adjusting a focus on a target subject. Here, each of the zoom lens and the focus lens may be formed of one lens but may also be formed of a group of a plurality of lenses.

The aperture 112 adjusts an amount of incident light by controlling its opening and closing.

The lens driving unit 111 and the aperture driving unit 113 may drive the lens unit 110 and the aperture 112, respectively, by receiving a control signal from the DSP unit 200. The lens driving unit 111 adjusts the focal length by adjusting positions of the lenses of the lens unit 110, and performs operations related to auto-focusing, zoom change, focus change, or the like. The aperture driving unit 113 adjusts a level of the opening and closing of the aperture 112, and in particular, the aperture driving unit 113 performs operations related to auto-focusing, auto-exposure compensation, zoom change, depth of field (DOF) adjustment, or the like by adjusting an F-number or a value of the aperture 112.

An optical signal passing through the lens unit 110 reaches a light-receiving surface of the image sensor 115 and forms an image of the target subject. The image sensor 115 may be a charge coupled device (CCD) or a complementary metal oxide semiconductor image sensor (CIS) to transform an optical signal into an electrical signal. The image sensor 115 is controlled by the DSP unit 200. In the present embodiment, the image sensor 115 may have at least two sensor modes. The image sensor 115 has a mode capable of capturing a moving picture at a normal speed and another mode capable of capturing a moving picture at a high or ultra-high speed. For example, the image sensor 115 may have modes capable of capturing 30 frames per second, 240 frames per second, 480 frames per second, and 1000 frames per second. The frame rates described above are examples and thus the present embodiment is not limited thereto. The sensor modes are changed by a sensor mode control signal of the DSP unit 200.

An exposure time period of the image sensor 115 is adjusted by a shutter (not shown). The shutter may include a mechanical-type shutter that adjusts incidence of light by moving a blind and an electronic-type shutter that controls exposure by supplying an electrical signal to the image sensor 115.

The manipulation unit 170 facilitates a user to input a control signal. The manipulation unit 170 may include various function buttons including a shutter-release button for generating a shutter-release signal for exposing the image sensor 115 to light for a predetermined time period in order to capture a picture, a power button for powering on or off the digital camera 100, a wide-angle zoom button and a telescopic zoom button for widening and narrowing an angle of view according to user manipulation, and various function buttons for selecting a mode from among a text input mode, a photographing mode, a reproducing mode, a white balance setting mode, an exposure setting mode, and the like. Also, according to the present embodiment, the manipulation unit 170 may separately include a moving picture photographing button so as to capture a moving picture, and a moving picture photographing mode dial for selecting whether moving picture photographing is to be performed at a normal speed or at a high speed, and thus a moving picture is captured at the normal speed or the high speed by manipulating the shutter-release button. The manipulation unit 170 may have various buttons as described above but is not limited thereto. Thus, the manipulation unit 170 may be embodied into any of various forms such as a keyboard, a touchpad, a touch screen, a remote controller, or the like.

The digital camera 100 includes the program storage unit 130 for storing programs, such as an operation system for driving the digital camera 100 and an application system, the buffer 140 for temporarily storing data necessary for performing calculations and result data, and the data storage unit 150 for storing image files containing image signals and various types of information that is necessary for the programs.

According to the present embodiment, captured moving picture data or moving picture frames are temporarily stored in the buffer 140.

In addition, the digital camera 100 includes the display unit 160 for displaying an operation state of the digital camera 100 or displaying still images or moving pictures captured by the digital camera 100. In order to provide visual information, the display unit 160 may be formed as a liquid crystal display (LCD) panel, an organic light emitting diode (OLED) panel, or the like. The display driving unit 162 provides a driving signal to the display unit 160.

The digital camera 100 includes the DSP unit 200 for processing an input image signal and controlling each of the aforementioned units according to the input image signal or to an externally input signal. The DSP unit 200 may reduce noise of input image data and may perform image signal processing, such as Gamma correction, color filter array interpolation, color matrix, color correction, color enhancement, and the like, for image quality improvement. Also, the DSP unit 200 may generate a moving picture file by compressing image data generated by performing the image signal processing for image quality improvement. An image compression format may be reversible or irreversible. The compressed image data may be stored in the data storage unit 150. Also, the DSP unit 200 may perform functional processing including clearness processing, color processing, blur processing, edge emphasis processing, image interpretation processing, image recognition processing, image effect processing, and the like. The image recognition processing may include face recognition processing, scene recognition processing, and the like. For example, the DSP unit 200 may perform brightness level adjustment, color correction, contrast adjustment, outline emphasis adjustment, screen division processing, character image generation, image composition processing, and the like.

Also, the DSP unit 200 may execute a program stored in the program storage unit 130 or may include a separate module to generate a control signal so as to control the auto-focusing, the zoom change, the focus change, or the auto-exposure adjustment, to provide the control signal to the lens driving unit 111, the aperture driving unit 113, and an image sensor control unit 116, and to wholly control operations of components such as the shutter, a flash, or the like included in the digital camera 100.

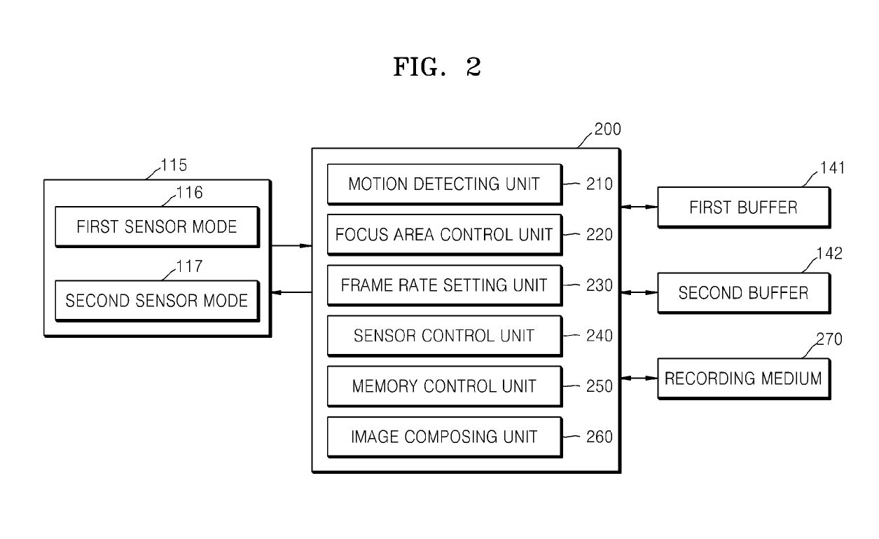

FIG. 2 is a block diagram of the DSP unit 200 of FIG. 1 and its peripheral devices, according to an embodiment.

Referring to FIG. 2, the DSP unit 200 includes a motion detecting unit 210, a focus area control unit 220, a frame rate setting unit 230, a sensor control unit 240, a memory control unit 250, and an image composing unit 260. The image sensor 115 has a first sensor mode 116 and a second sensor mode 117, outputs captured frames to the DSP unit 200, and changes a sensor mode according to a control of DSP unit 200. A first buffer 141 and a second buffer 142 temporarily store the captured frames. For example, the buffer 141 stores frames captured in the first sensor mode 116, and the second buffer 142 stores frames captured in the second sensor mode 117. Here, the first buffer 141 and the second buffer 142 may be physically separate from each other or may be in different parts of a memory area of a single buffer. A recording medium 270 stores a file obtained by capturing a moving picture at a high speed.

The DSP unit 200 performs image processing on a moving picture captured by the image sensor 115 and stores the moving picture in the recording medium 270. Here, the moving picture captured by the image sensor 115 is image-processed frame by frame.

The motion detecting unit 210 detects a moving target object in an image input via the image sensor 115. The target object detection is performed by finding a target object according to an object detection method and by detecting movement of the detected target object. Here, the input image indicates moving picture data having a predetermined number of frames. The movement detection may be performed by calculating motion vectors of consecutive frames, by calculating horizontal and vertical change rates of an image, or by calculating likelihood of movement from difference images between previous and following frames. Various well known methods may be used for the movement detection, and thus the movement detection is not limited to the calculation methods described above.

In a case where the moving target object is detected in the input image, the focus area control unit 220 sets an area including the moving target object as a focus area. In more detail, the focus area control unit 220 determines a speed of the detected moving target object, and if the speed of the detected moving target object is equal to or greater than a first threshold value, the focus area control unit 220 sets the area including the moving target object as the focus area. Here, the speed of the detected moving target object may be calculated based on a movement distance of the moving target object existing in consecutive frames, and the first threshold value is a reference value used to set a current frame rate as a high speed frame rate when the current frame rate is not appropriate for capturing rapid movement of the moving target object. Also, according to the present embodiment, in a case where a rapidly moving target object appears while a moving picture is captured at a normal speed, only an area including the rapidly moving target object is set as a focus area, and a current frame rate for the focus area is photographed is changed to a frame rate that is appropriate for high speed moving picture photographing. For example, in a case where a rapidly moving target object is detected while a moving picture is captured at 30 frames per second (fps), only a focus area including the rapidly moving target object is changed to 1000 fps and is photographed. Thus, high speed moving picture photographing is performed on only a corresponding focus area to obtain a high speed moving picture, and thus it is possible to overcome a restriction regarding a data amount that may be processed, to perform high resolution photographing, and to capture a target object that suddenly appears and then disappears. The frame rate setting unit 230 sets a frame rate for the focus area according to the determined speed of the moving target object. Here, examples of the frame rate may be 30 fps, 240 fps, 480 fps, 1000 fps, and the like, and the frame rate may vary according to specifications of the image sensor 115. For example, when a speed of a target object is highly rapid, the frame rate may be set as 1000 fps, and when a speed of a target object is rapid, the frame rate may be set as 480 fps.

The sensor control unit 240 changes a sensor mode of the image sensor 115 so as to match the frame rate set by the frame rate setting unit 230. As illustrated in FIG. 2, it is assumed that the image sensor 115 has two sensor modes, that is, the first sensor mode 116 and the second sensor mode 117. Here, the first sensor mode 116 is a normal moving picture photographing mode in which a moving picture is captured at 30 fps, and the second sensor mode 117 is a high speed moving picture photographing mode in which a moving picture is captured at 1000 fps. In a case where a moving target object is detected in an input image while a moving picture is captured in the first sensor mode 116 at 30 fps, in particular, if a speed of the moving target object is significantly rapid, the sensor control unit 240 outputs a sensor mode control signal so as to change the first sensor mode 116, which is the current mode, to the second sensor mode 117. Afterward, the image sensor 115 photographs a focus area including the moving target object, wherein the focus area is set by the focus area control unit 220, according to the second sensor mode 117.

The memory control unit 250 controls frames respectively captured in the sensor modes 116 and 117 of the image sensor 115 to be stored in the respective buffers 141 and 142. For example, image frames captured in the first sensor mode 116 at 30 fps are controlled to be stored in the first buffer 141, and image frames captured in the second sensor mode 117 at 1000 fps are controlled to be stored in the second buffer 142. Here, the first buffer 141 and the second buffer 142 may be physically separate, or in one buffer having different storage regions.

The image composing unit 260 combines the image frames stored in the first buffer 141 with the image frames stored in the second buffer 142. The combined image frames are stored in the recording medium 270. Here, the image frames stored in the first buffer 141 are frames that are captured at 30 fps, and the image frames stored in the second buffer 142 are frames that are captured at 1000 fps. According to the present embodiment, compared to movement of a moving target object, movement around the moving target object is small or its speed is significantly slower than a speed of the moving target object, and thus normal moving picture photographing is performed on an area that does not include movement, and an image obtained by the normal moving picture photographing is stored. That is, high speed photographing is not performed on an entire current area due to a limitation regarding an amount of data that can be processed at one time. In the present embodiment, since an image is divided into a focus area and a background area and then different frame rates are applied to the focus area and the background area, respectively, a resolution restriction due to high speed moving picture photographing is reduced and thus it is possible to capture a high resolution moving picture.

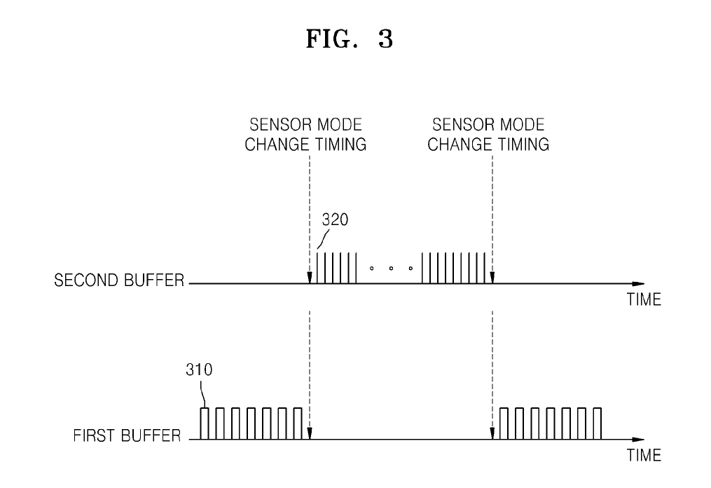

FIG. 3 illustrates graphs describing moving picture frames stored in the first buffer 141 and the second buffer 142, according to an embodiment.

Referring to FIG. 3, when moving picture photographing starts, frames 310 of an image are captured at a currently set frame rate, e.g., 30 fps, and stored in the first buffer 141. The DSP unit 200 analyzes the frames 310, detects a moving target object, and determines whether to change a sensor mode by determining a speed of the moving target object. That is, when a moving target object is detected in the frames 310, in particular, when a rapidly moving target object is detected, the DSP unit 200 sets a focus area including the moving target object and changes a sensor mode.

In sensor mode change timing, frames 320 are captured at 1000 fps and are stored. Here, the stored frames 320 are obtained by photographing the focus area, that is, the stored frames 320 are images that are captured while following the moving target object, and a background area excluding the focus area is not photographed. Afterward, in next sensor mode change timing, additional frames 310 are captured at 30 fps and stored in the first buffer 141. In a case where the moving target object disappears offscreen, a sensor mode is changed again so as to decrease unnecessary memory use.

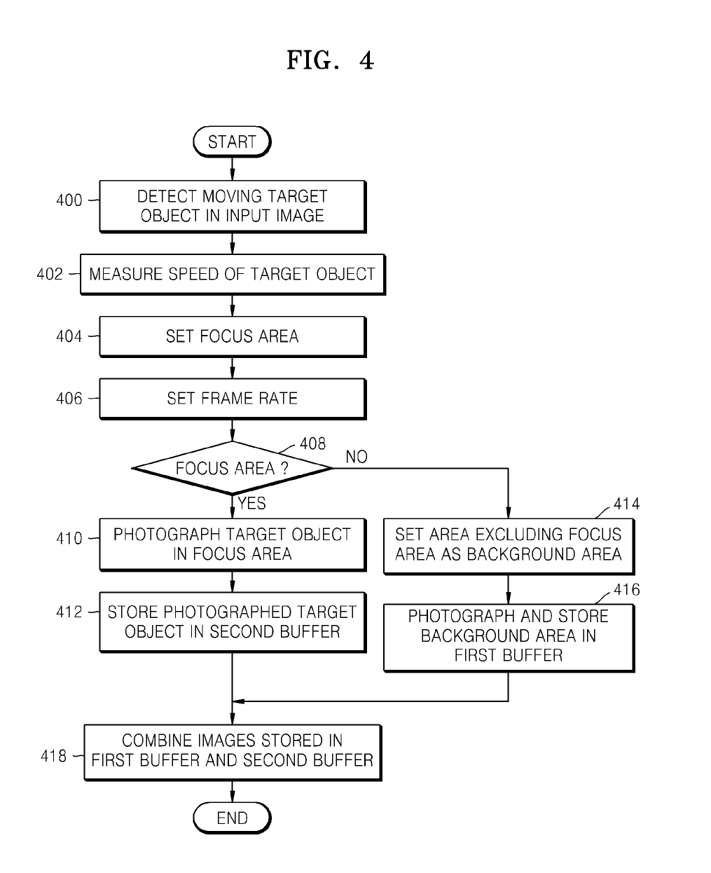

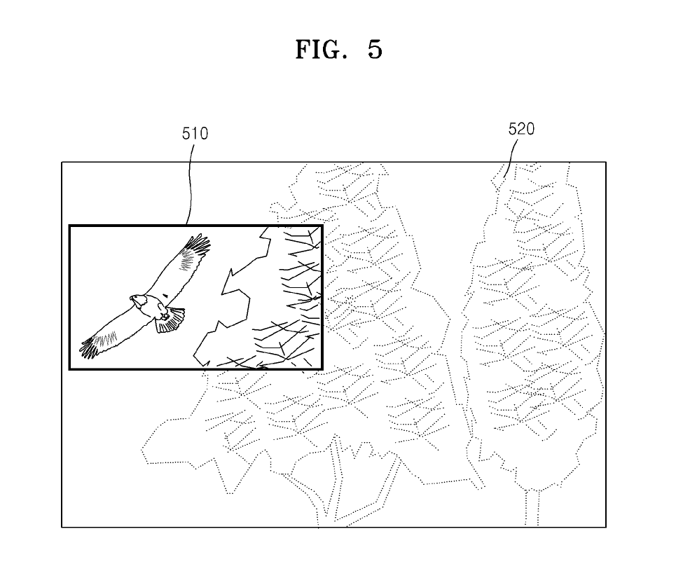

FIG. 4 is a flowchart describing a method of capturing a moving picture, according to an embodiment. FIG. 5 illustrates an exemplary screen displaying a result image according to the method of capturing a moving picture

Referring to FIG. 4, in operation 400, a moving target object is detected in an input image. That is, a target object is detected in frames of the input image, and then movement of the target object is detected. In operation 402, a speed of the target object is measured. The speed of the target object is determined by using a motion vector of the target object detected in the frames of the input image. In operation 404, a focus area is set. In this regard, an area including the moving target object is set as the focus area. In operation 406, a frame rate is set. If it is determined that the speed of the target object is fast, that is, if it is determined that it is difficult to perform photographing at a current frame rate, a frame rate faster than the current frame rate is set. In operation 408, in a case of the focus area, in operation 410, the focus area including the target object is photographed, and in operation 412, images of the photographed focus area are stored in a second buffer. That is, the focus area including the moving target object is photographed at the frame rate set in operation 406, and the images thereof are stored in the second buffer.

In operation 408, in a case of a non-focus area, in operation 414, an area excluding the focus area is set as a background area, and in operation 416, the background area is photographed and images of the photographed background area are stored in a first buffer. The background area does not include movement or includes only movement that may be photographed at the current frame rate, and thus the background area is photographed at the current frame rate and the images thereof are stored in the first buffer.

In operation 418, the images stored in the second buffer and the images stored in the first buffer are combined. That is, the images that are obtained by photographing the focus area at a high speed and that are stored in the second buffer in operation 412, and the images obtained by photographing the background area at a normal speed in operation 416 are combined. While it is described that the images stored in the first buffer are obtained by photographing the background area, the images may instead be obtained by photographing an entire area including the focus area, and the composition may be performed by replacing the focus area in the images stored in the first buffer with the images stored in the second buffer. As illustrated in FIG. 5, reference numeral 510 indicates a focus area photographed at a high speed, and reference numeral 520 indicates a background area photographed at a normal speed. In the focus area 510, a target object rapidly moves and thus high speed photographing is performed while following the target object, but in the background area 520, there is no movement and thus photographing is performed at the normal speed. By doing so, a resolution restriction of a case in which an entire area is photographed at a high speed is not applied to a case of FIG. 5.

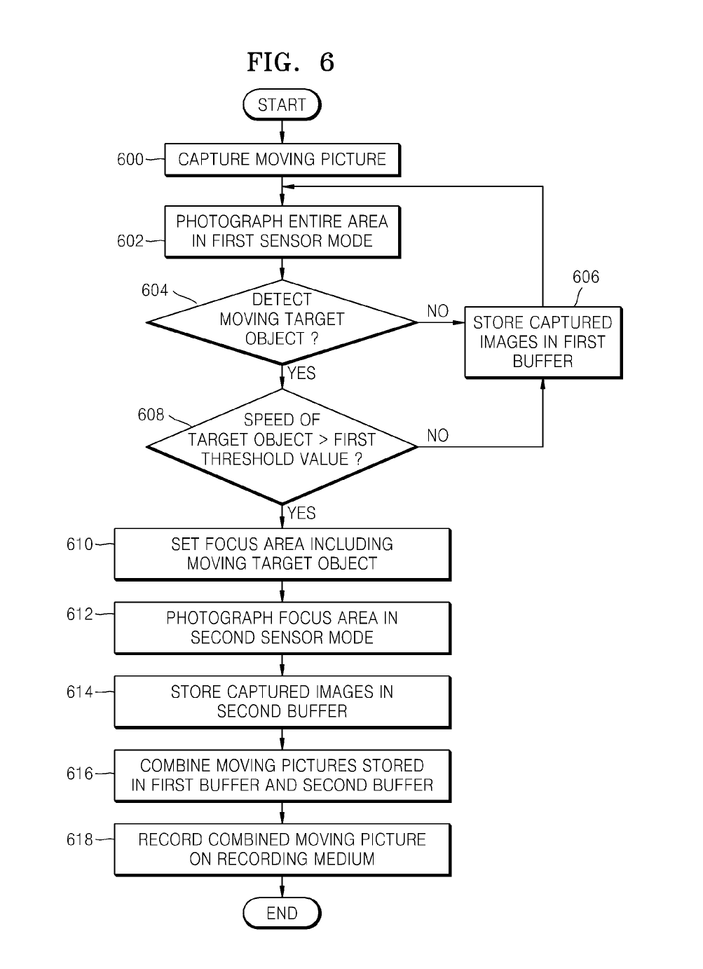

FIG. 6 is a flowchart describing a method of capturing a moving picture, according to another embodiment.

Referring to FIG. 6, in operation 600, a moving picture is captured. Here, a moving picture photographing mode may be a high speed moving picture photographing mode, and the capturing of the moving picture starts when a moving picture photographing button or a shutter release button is pressed by a user in the moving picture photographing mode. In operation 602, an entire area is photographed in a first sensor mode. When the capturing of the moving picture starts, the entire area is photographed in the first sensor mode, e.g., the entire area is photographed at 30 fps for a predetermined number of frames or during a predetermined time period. If in operation 604 a moving target object is detected in the frames, then in operation 608, it is determined whether a speed of the moving target object is equal to greater than a first threshold value. Here, the first threshold value may be arbitrarily set, and the first threshold value may be a reference value that is used to determine whether it is acceptable to photograph the moving target object at a current frame rate, e.g., 30 fps. If in operation 604 there is no moving target object in the frames, or if in operation 608 it is determined that the speed of the moving target object is less than the first threshold value, then in operation 606, the images are stored in a first buffer. That is, after analyzing frames of the images, if there is no moving target object or if there is a moving target object that can acceptably be photographed at the current frame rate, the images obtained by photographing the entire area are stored in the first buffer. However, in a case where movement occurs in images that are obtained by photographing background areas and that are stored in the first buffer, the images may be updated and stored.

In operation 610, a focus area is set to include the moving target object at a center of the focus area. In a case where the speed of the moving target object is equal to greater than the first threshold value in operation 608, the focus area is set to include the moving target object. Here, a background area that is an area excluding the focus area does not include movement or includes movement that can acceptably be photographed at the current frame rate, and thus high speed photographing does not need to be performed on the background area.

In operation 612, the focus area is photographed in a second sensor mode. For example, the focus area is photographed at 1000 fps. In operation 614, captured images are stored in a second buffer.

In operation 616, moving pictures stored in the first and second buffers are combined.

In operation 618, the combined moving pictures are recorded on a recording medium.

According to the one or more embodiments, the moving picture photographing apparatus may capture a high resolution moving picture by reducing a resolution restriction due to high speed moving picture photographing. Also, a user may conveniently perform high speed photographing while automatically focusing on a moving target object, and may store more moving pictures due to efficient memory use.

The one or more embodiments may include a processor, a memory for storing and executing program data, a permanent storage including a disk drive, a communication port for communication with an external device, a user interface device including a touch panel, a key, a button, and the like. The methods embodied as a software module or an algorithm may be stored as computer readable codes or program commands that are executable on the processor in a non-transient computer readable recording medium. The computer readable recording medium is any data storage device that can store data which can be thereafter read by a computer system. Examples of the computer readable recording medium include magnetic storage mediums (e.g., hard disks, etc.) and optical reading mediums including CD-ROMs, DVDs, etc. The computer-readable recording medium can also be distributed over network-coupled computer systems so that the computer-readable code is stored and executed in a distributed fashion. The mediums can be read by computers, can be stored in the memory, and can be executed on the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention as defined by the following claims should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Using the disclosure herein, programmers of ordinary skill in the art to which the invention pertains may easily implement functional programs, codes, and code segments for making and using the invention. Furthermore, the invention may employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

What is claimed is:

1. A method of capturing a moving picture, the method comprising:
capturing an input image at a first frame rate;
detecting a target object that moves in the input image;
photographing a focus area including the target object at a second frame rate; and
combining a first image captured at the first frame rate with a second image captured at the second frame rate.

2. The method of claim 1, wherein a frame rate for capturing the input image varies according to a speed of the target object.

3. The method of claim 1, further comprising:
storing the first image in a first buffer; and
storing the second image in a second buffer.

4. The method of claim 1, further comprising recording the combined image on a recording medium.

5. The method of claim 1, further comprising:
determining a speed of the target object; and
when the speed of the target object is more than a first threshold value, setting the focus area comprising the target object.

6. The method of claim 1, wherein the capturing of the input image comprises capturing the input image at the first frame rate for a predetermined number of frames.

7. The method of claim 1, wherein the first image comprises a background area excluding the focus area.

8. The method of claim 1, further comprising, when a moving target object is detected in the first image, updating the focus area.

9. A method of capturing a moving picture, the method comprising:
detecting a target object that moves in an input image;
setting a frame rate for capturing the input image according to a speed of the target object; and
capturing the input image according to the frame rate.

10. The method of claim 9, further comprising setting a focus area comprising the target object,
wherein the setting of the frame rate comprises setting the frame rate as a faster frame rate with respect to the focus area, compared to a previously set frame rate.

11. The method of claim 9, further comprising:
setting a focus area comprising the target object in the input image, and a background area excluding the focus area;
storing a first image captured at a first frame rate with respect to the background area;
storing a second image captured at a second frame rate faster than the first frame rate with respect to the focus area; and
combining the first image with the second image.

12. A moving picture photographing apparatus comprising:
an image sensor comprising at least two sensor modes that capture an input image at different frame rates; and
a digital signal processing (DSP) unit that detects a target object that moves in the input image, and controls a focus area comprising the target object to be photographed at a frame rate faster than a previously set frame rate.

13. The moving picture photographing apparatus of claim 12, wherein the image sensor comprises:
a first sensor mode that captures the input image at a first frame rate; and
a second sensor mode that photographs the focus area at a second frame rate.

14. The moving picture photographing apparatus of claim 13, further comprising:
a first buffer that stores a first image obtained by capturing the input image at the first frame rate; and
a second buffer that stores a second image obtained by photographing the focus area at the second frame rate,
wherein the DSP unit combines the first image stored in the first buffer with the second image stored in the second buffer.

15. The moving picture photographing apparatus of claim 12, wherein the DSP unit comprises:
a motion detecting unit that detects a target object that moves in the input image;
a focus area control unit that sets a focus area comprising the target object when a speed of the target object is equal to or greater than a first threshold value;
a frame rate setting unit that sets a frame rate for photographing the focus area according to the speed of the target object; and
a sensor control unit that determines a sensor mode of the image sensor according to the set frame rate.

16. The moving picture photographing apparatus of claim 15, wherein the image sensor comprises:
a first sensor mode that captures the input image at a first frame rate; and
a second sensor mode that photographs the focus area at a second frame rate, and
the DSP unit further comprises a memory control unit that controls a first image captured at the first frame rate to be stored in a first buffer and controls a second image captured at the second frame rate to be stored in a second buffer.

17. The moving picture photographing apparatus of claim 16, wherein the DSP unit further comprises an image composing unit that combines the first image stored in the first buffer with the second image stored in the second buffer.

18. The moving picture photographing apparatus of claim 12, wherein the DSP unit variably sets a frame rate for capturing the input image, according to a speed of the target object.
